(19) United States
(12) Patent Application Publication
(10) Pub. No.: US 2018/0073484 A1
(43) Pub. Date: Mar. 15, 2018

(54) Air Driven Buoyancy Wheel

(71) Applicant: Mark Joseph Maynard, Easthampton, MA (US)

(72) Inventor: Mark Joseph Maynard, Easthampton, MA (US)

(21) Appl. No.: 15/261,964

(22) Filed: Sep. 11, 2016

(51) Int. Cl. F03B 17/02

(52) U.S. Cl. CPC F03B 17/02

(57) ABSTRACT

This invention is a renewable energy generator. This is a device for converting low pressure gas into a buoyancy force to create mechanical energy. The device consists of a round cylinder tank with a large radius containing a fluid where the aspect ratio of the round height over width greatly favors the height. Inside this tank is a submerged wheel with a plurality of cups between two supporting rings on the perimeter of the wheel. The rings are connected to a centralized hub and shaft which extend through the sides of the tank at the center. Air or gas is injected in the lower section of the tank to fill the cups and displace the fluid. The displacement of fluid creates an unbalance upward buoyancy force and rotates the wheel along the perimeter which turns the shaft and drives other devices in particular electric alternators to produce renewable electricity.

### CROSS-REFERENCE TO RELATED APPLICATIONS

1. Low-drag hydro-pneumatic power cylinder and system (U.S. Pat. No. 8,833,070).
2. Decentralized source separation sewage system (U.S. Pat. No. 8,197,201).
3. Motor with eccentrically shift able buoyant rotor member (U.S. Pat. No. 4,471,613).
4. Radiation shadow projection exposure system (U.S. Pat. No. 4,348,105).
5. Fluid motor (U.S. Pat. No. 4,245,473).
6. Force Converting Device (U.S. Pat. No. 3,860,355).
7. Device for obtaining internal energy from liquid by utilizing buoyancy and method therefore (U.S. Pat. No. 8,919,111).
8. This invention is based on the provisional patent filed Sep. 11, 2015 application No. 62/283,782 by Mark J. Maynard.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to devices which use low pressure gas from compressors, industrial or natural sources to create a buoyancy force in a fluid to develop mechanical energy.

Buoyancy wheel devices are known which extract energy from gases in the form of buoyancy and convert it to mechanical energy. Generally these apparatuses are comprised of a vaned wheel submerged or partially submerged under a fluid. A supply of gas is introduced at the bottom of the wheel where the gas displaces the fluid inside the compartment formed by the vanes and rings of the wheel. The displacement of the fluid in the compartment creates an unbalanced buoyancy force in the wheel which creates a rotational torque and the wheel rotates. (See for example, U.S. Pat. No. 211,143 and U.S. Pat. No. 6,995.)

In the past buoyancy devices aspect ratio of the height over the width was either the same or favored the width. In this device, the aspect ratio of the height over width of the tank does greatly favor the height. This condition is critical because it increases the time on which the buoyancy force acts upon the wheel. The longer the air is applying the force the more energy is created. The narrow tank also reduces the amount of fluid needed to overcome inertia to move with the wheel.

The majority of past buoyancy devices were placed in square tanks. The shape of the enclosing tank must be round. In addition, baffles which interrupt the flow of fluid around the tank (as in U.S. Pat. No. 8,833,070 B2) to facilitate bubbling gas into the buoyancy cups actually remove as much energy as the device creates by arresting the inertia of the fluid developed by the moving wheel. An unobstructed round tank provides for the condition where, when the wheel begins to turn, the fluid in the tank can overcome inertia and move at nearly the same speed as the wheel. Once the starting momentum of the fluid is overcome there is very little drag on the wheel itself. Wheeled turbines placed in square tanks have to continuously expend energy to overcome the turbulence created as fluid is forced into the corners and rebounds out into the path of the wheel creating significant drag.

Previous buoyancy devices had single point gas injection ports or used micro bubble infusers to introduce the gas into a fast moving wheel. This combination delivered small amounts of gas in each buoyancy cup. The gas required to create a meaningful amount of buoyancy requires high volumes of gas over multiple ports for as long of a period of time as possible. If you use a single point injection, you get much less buoyancy development especially in a fast moving wheel. Fast moving wheels develop higher rates of boundary sheer with the sides of the tank. If the speed is too fast, the drag will climb quickly and dissipate a significant amount of power.

Some previous devices use a diffuser along the width of the buoyancy cups. This condition will cause turbulence between the smooth exchange of gas into the cups and fluid out of the cups. This will drastically reduce the net power output because gas will escape on the outside of the wheel and provide no buoyancy.

Previous devices used small diameter wheels which do not take advantage of the residence time of the gas in the fluid and the moment arm of the radius of the wheel. This reduced the residence time the gas generated the buoyancy force. The diameter of the wheel is important because the larger the wheel, the more filled cups are involved with the generation of the buoyancy force for a longer period of time. Also keeping the injected gas as far to the outside of the cup as possible is important because gas that slips to the center of the wheel as in some of the previous devices offer little buoyancy until the wheel orientates high enough for the gas to move to the outside of the wheel.

### BRIEF SUMMARY OF THE INVENTION

This new invention provides the best way to make a continuous source of renewable energy virtually anywhere on earth with either a natural source of gas or by compressing the air with a low pressure compressor. The current limit and drawback on renewable energy devices is the inability to supply power on demand and the need for specific environmental requirements to operate the device. This air driven buoyancy device can supply power at anytime anywhere for as long as the power is needed. With the improvements in this device, net power outputs have been as high as 300% of the power needed to supply the low pressure gas with a compressor. This is a net gain of renewable power of 200%. Previous devices never used all of the critical elements to maximize the buoyancy of the gas being used in the device to achieve a positive net gain in power. Each previous invention focused on only a few parts of the necessary elements to achieve full power so they only received a partial benefit of the possible buoyancy force.

### BRIEF DESCRIPTION OF THE SEVERAL VIEWS OF THE DRAWINGS

The embodiments of the present invention described below are not intended to be exhaustive or limit the invention to the precise forms disclosed in the following detailed description. Rather, the embodiments are chosen and described so that others skilled in the art may appreciate and understand the principles and practices of the present invention.

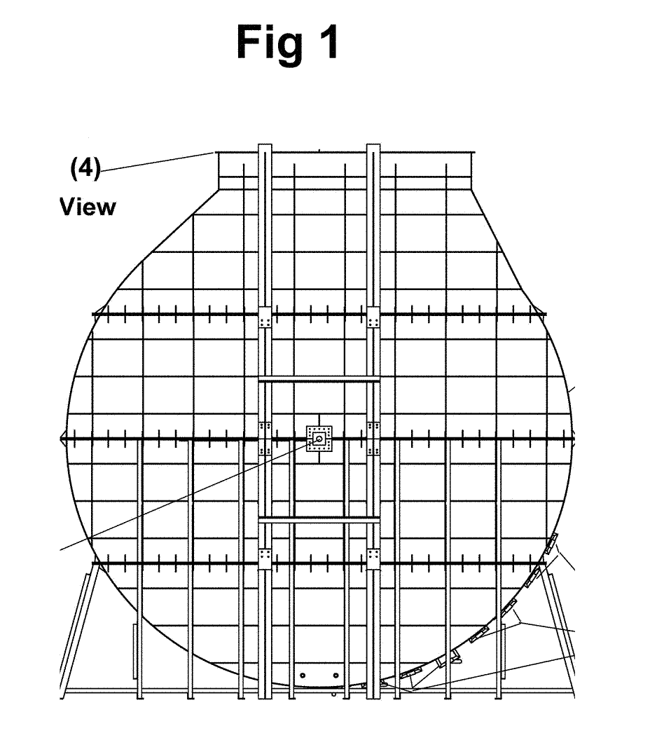

1. FIG. 1 shows a from view of buoyancy device.

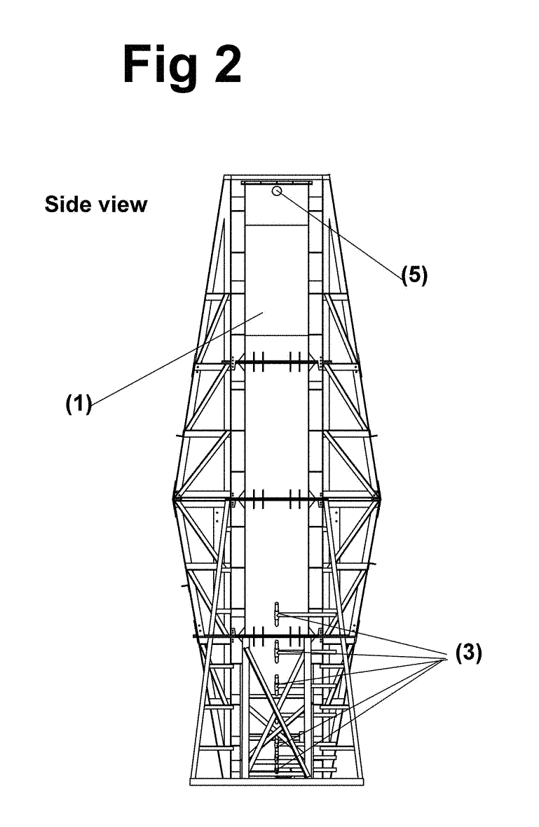

2. FIG. 2 shows a side view of buoyancy device.

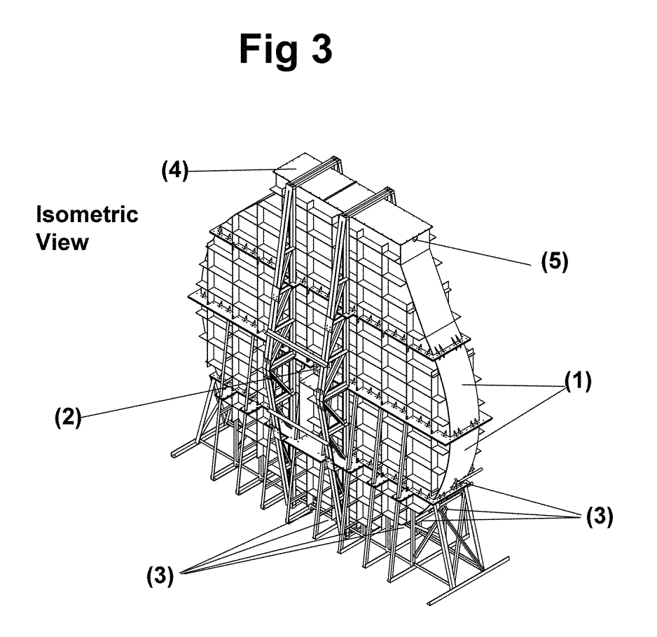

3. FIG. 3 shows an isometric view of buoyancy device with both the front and side view.

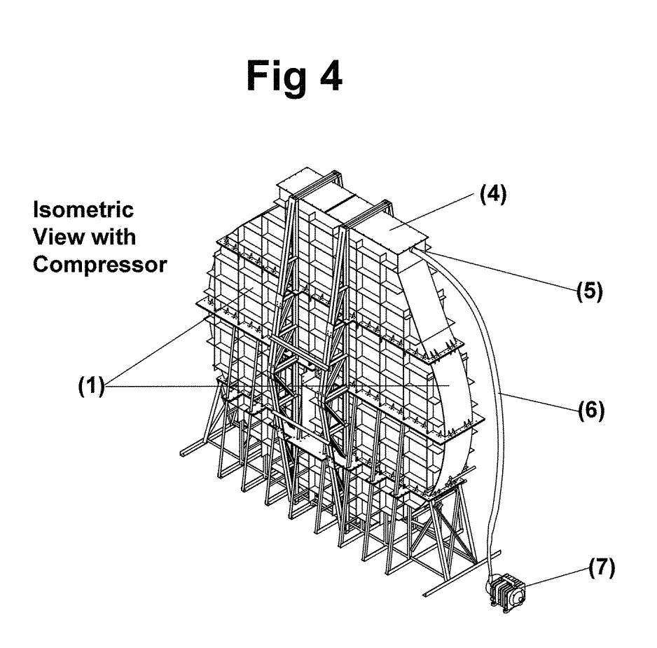

4. FIG. 4 shows a similar isometric view with compressor.

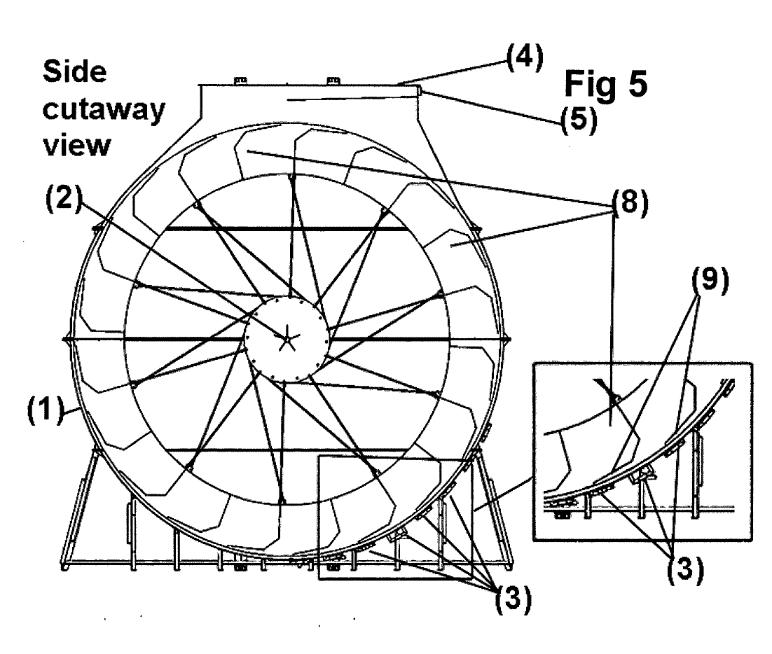

5. FIG. 5 shows a front cutaway view with close up section of buoyancy device.

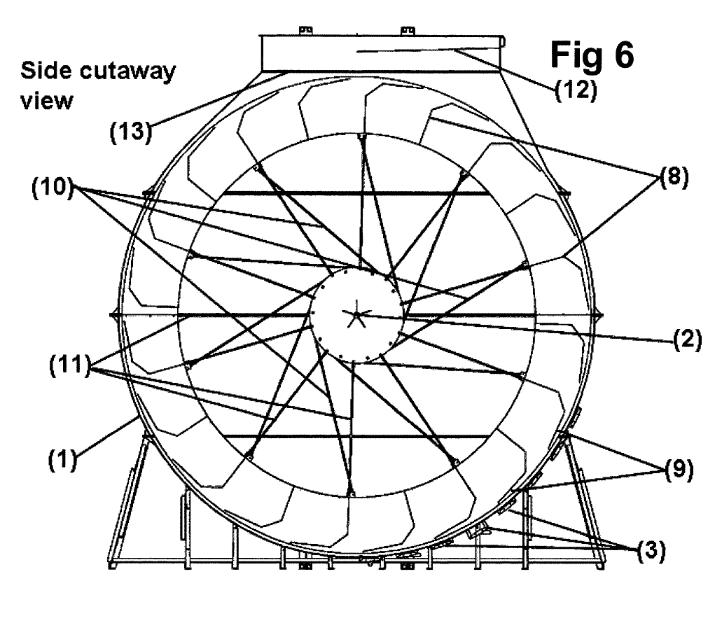

6. FIG. 6 is a similar front cutaway view of buoyancy device.

### DETAILED DESCRIPTION OF THE INVENTION

The present invention relates generally to devices which use low pressure gas from compressors, industrial or natural sources to create a buoyancy force in a fluid to recover mechanical energy.

This invention is based on the provisional patent filed Sep. 11, 2015 application No. 62/283,782 by Mark J. Maynard.

The present invention provides a considerable improvement over previous buoyancy devices. In the past, devices operated in the area of recovering a part of the energy needed to drive the device. This invention produces a significant net gain in power and therefore is a renewable energy device.

This invention is a large round cylinder tank (1) where the aspect ratio of the height over width of the tank greatly favors the height as seen in FIG. 2 and FIG. 3. The tank is filled with a fluid (13) and a cupped (8) wheel is wholly immersed under the fluid as seen in FIG. 6. (13) The wheel is made up of a plurality of large cups (8) fitted between two rings located on the outside perimeter of the wheel. The rings of the wheel are fitted with tensioning rods (10) between the rings and hub (14) capable of conducting the huge forces of buoyancy down to a hub (14) and shaft (2). In FIGS. 5 & 6 you can see the tensioning rods (10) and hub (14) which transfers the energy to the shaft (2). The wheel is also fitted with lateral stabilizing rods (11) to hold the wheel aligned in the center of the tank and to keep the ring round. The tall aspect ratio is critical because it increases the time on which the buoyancy force acts upon the wheel. The longer the air is applying the force, the more energy is created. The narrow tank (1) as seen in FIG. 2 also reduces the amount of fluid that needs to overcome inertia to move with the wheel. The wheel holding the buoyancy cups (8) must be fully immersed under the fluid (13) in the tank otherwise partially empty cups will be forced under the fluid. The force of dunking the cups (8) will generate a counter rotating force and reduce the overall production of power.

The shape of the enclosing tank must be round (1). FIG. 1 shows a front view of buoyancy device. The round tank (1) with a shaft extending through the center (2) is clearly shown. This is a critical improvement over previous devices with square tanks. Round tanks have a smooth movement of fluid around the tank with little drag or turbulence. An unobstructed round tank provides for the condition where as the wheel begins to turn, the fluid in the tank can overcome inertia and move at nearly the same speed as the wheel. Once the starting momentum of the fluid is overcome, there is very little drag on the wheel itself. Wheeled turbines placed in square tanks have to continuously expend energy to overcome the turbulence created as fluid is forced into the corners and rebounds out into the path of the wheel creating significant drag.

The speed of the wheel is also critical. The wheel must turn slowly at only a few rpm. The gas is optimally injected at the bottom of the tank as seen in FIG. 1 (3) and only on the upward moving side of the wheel. Previous buoyancy devices had single point gas injection ports or used micro bubble infusers to introduce the gas into the device. The gas required to create a meaningful amount of buoyancy requires high volumes of gas with multiple injection ports over as long of a period of time as possible. About 19% to 22% of the circumference of the wheel can have gas loaded into the cups (8) at any given time so the critical factor is the amount of time the gas can be injected and the amount of gas available to inject during that time interval. At six rpm, there is only 1.9 seconds to inject the gas into the load bearing cups assuming about 19% of the tank injectable area is used. Even if the gas source can deliver 2 cu ft per sec at pressure with multiple ports this adds up to only 3.8 cu ft of gas per cup. If a single point injection is used, the amount of gas in each cup would be significantly reduced. So there are two options to address this issue—slow the speed of the wheel down to allow more time to fill the cups (8) and make more gas which costs more energy. The solution is a combination of both—slow the wheel down to less than 3.5 rpm and make as much gas as efficiently as possible and more importantly inject the gas over as much of the 19% injectable portion of the circumference of the tank as possible. This will increase the injection time to 3.2 seconds or greater and allow more gas to fill into each cup providing a greater buoyancy force. Another reason for a slow moving wheel is to keep the boundary sheer away from the sides of the tank and reduce drag. The tank is sized in a manner to allow only a few inches of space around all sides of the wheel to reduce the effects of boundary sheer between the wheel and the tank and to minimize the volume of fluid needed to fill the tank.

The gas must be injected along the center line of the tank through large unobstructed manifold ports as seen in FIG. 2 (3). Because large amounts of gas needs to be exchanged in a very short period of time, the center position of the injection ports is critical to allow a smooth transmission of gas into the cups and fluid out of the cups. Keeping the manifold apertures large reduces the back pressure on the compressor or source gas which lowers the energy needed to compress or deliver the gas. FIG. 5 shows the gas injection ports (3) are large enough to not restrict the flow of gas and develop a back pressure raising the energy to deliver the gas. If the gas passing through the apertures of the manifold into the tank is constant, the flowing gas will form a tunneling effect between the port and cup which allows more gas to pass than if it was to pass through the fluid. This action further reduces back pressure on the compressor or gas source. The manifold injection ports must be located as close to the wheel cups as possible to shorten the time and distance the gas travels from the manifold apertures to entering the cup. FIG. 5 shows a front cutaway view with close up section of buoyancy device and in the blowup section shows the plurality of buoyancy cups (8) around the tank (1) in very close proximity (9) to the sides of the tank (1) and the injection ports (3). As seen in FIG. 2, the injection port manifolds (3) are clearly in the center of the tank and extend along the entire length of the 19% to 22% of the gas injectable area of the tank to provide a smooth transmission of gas into each cup and a likewise smooth exit of the fluid from the sides of the cup (8). The exiting fluid from each cup should closely match the speed of the turning wheel so the exiting fluid does not cause any appreciable turbulence in the moving fluid therefore the subsequent cups can fill as smoothly as the previous cups.

The gas source in most cases will originate from a low pressure compressor (7). The adiabatic heat from even low pressure air will heat up the fluid in the tank. So aqueous base liquids will see a rise in the entropy of the fluid and dispose of a large portion of the heat in the form of evaporation. The constant evaporation would require some type of auto fill system or constant maintenance to keep the fluid at a constant level (13) and could also lead to a buildup of salts and eventual corrosion of the tank. This problem is solved by recycling the evaporated air back through the compressor (7). FIG. 4 shows an isometric view with the exhaust port (5) connected with a pipe (6) to a compressor (7) for recirculation of gas. The evaporated fluid is essentially distilled water so it does not harm the compressor and the recompression of exhausted air returns the lost fluid back to the device tank and substantially reduces the need for constant replenishment of the loss fluid. This also eliminates the need to filter the incoming air for compression because there is no dust coming from the tank. A baffle (13) placed at the top of the tank suppresses any splashing or atomized fluid in the air from entering the gas return system. FIG. 5 shows the location of the exhaust port (5) above the baffle (12) in the tank which prevents the atomized particles from leaving the tank and entering the pipe to the compressor. This arrangement controls evaporation and maintains PH levels. The recompression of the exhaust air also solves another issue. If the device uses a proprietary dense fluid, then fluid corrosion control mechanism is PH driven. The constant contact with the oxygen in the air causes a chemical reaction which will slowly lower the PH and the fluid will then allow corrosion to occur. If the tank is sealed (4) and pressure equalizing vents are installed there will be a constant recirculation of the same air. The oxygen will slowly get used up in the chemical reaction and the air will become oxygen poor. The oxygen poor environment will prolong the corrosion protection of the fluid and reduce the need to adjust the PH of the fluid on a regular basis.

Previous devices used small diameter wheels which do not take advantage of the residence time of the gas in the fluid and the longer moment arm of the radius of the wheel. The diameter of the wheel is important because the larger the wheel the more filled cups (8) are involved with the generation of the buoyancy force for a longer period of time. The larger diameter wheel also has a large moment arm which significantly raises the torque of the moving wheel and output shaft (2). Sizing the cups large enough to hold the required amount of displacing gas is accomplished much easier in a large diameter wheel without reducing a significant portion of the moment arm. Simply the larger the wheel diameter, the larger the cup can be made with a greater percent portion of the moment arm. Also keeping the injected gas as far to the outside of the cup as possible is important because gas that slips to the center of the wheel offer little buoyancy until the wheel orientates high enough for the gas to move to the outside of the wheel. The diameter of the wheel is not unlimited. As the diameter of the wheel goes up so does the pressure in the fluid notably at the bottom of the tank. The rise in pressure requires more pressure in the incoming gas and therefore more energy to drive the compressor (7) to make the compressed gas. So this too is a balance of cost of energy to make the compressed gas, cost, size and weight of device and net output of power.

This whole system is based on the density of the fluid the wheel is immersed in. This invention can use a proprietary fluid with a density of almost twice that of water which significantly raises the net gain in output energy and minimally raises the pressure at the bottom of the tank for injection. Furthermore the rise in pressure required of the compressor is still below the minimal pressure needed for the compressor to work efficiently.

1. The aspect ratio of the tank and wheel must favor the height over the width to increase the residence time of the gas applying the force in the fluid and reduce the total mass of the fluid that needs to overcome inertia.

2. The shape of the enclosing tank must be round in the direction of the travel of the wheel supporting the buoyancy cups to reduce drag.

6. The gas must be injected along the centerline of the tank to provide a smooth transmission of the gas into the center of the buoyancy cups and a smooth exit of the fluid out the sides of the cups.
